(19) United States
(12) Patent Application Publication
(10) Pub. No.: US 2009/0285521 A1
(43) Pub. Date: Nov. 19, 2009

(54) OPTICAL FIBER SENSOR

(75) Inventors: Masaki KUNIGAMI, Tochigi (JP); Nobuhiro Fueki, Tochigi (JP); Masatoshi Kobayashi, Tochigi (JP); Makoto Furukawa, Tochigi (JP)

Correspondence Address: ARENT FOX LLP, 1050 CONNECTICUT AVENUE, N.W., SUITE 400, WASHINGTON, DC, 20036, US

(73) Assignee: HONDA MOTOR CO., LTD., Tokyo (JP)

(21) Appl. No.: 12/437,972

(22) Filed: May 8, 2009

(30) Foreign Application Priority Data
May 13, 2008 (JP) 2008-125938
Aug. 28, 2008 (JP) 2008-220003

(51) Int. Cl. G02B 6/00

(52) U.S. Cl. 385/13

(57) ABSTRACT

An optical fiber sensor which functions as a tactile sensor includes a plurality of shearing stress sensor sections including respective optical fibers and a plurality of gratings for reflecting light beams having predetermined wavelengths. The gratings are disposed in the optical fibers and arrayed along a plane parallel to the direction in which a shearing stress is applied from an object to the shearing stress sensor sections. The sensor also includes a perpendicular stress sensor section including an optical fiber and a plurality of gratings for reflecting a light beam having a predetermined wavelength. The gratings are disposed in the optical fiber and arrayed along a plane parallel to the direction in which a perpendicular stress is applied from the object to the perpendicular stress sensor section. Preferably, stress direction converting means such as elastic members for converting the direction of an applied stress are mounted on the optical fibers.

### BACKGROUND OF THE INVENTION

1. Field of the Invention

The present invention relates to an optical fiber sensor for detecting stresses with an optical fiber which incorporates therein a plurality of gratings for reflecting light beams having certain wavelengths.

2. Description of the Related Art

In some manipulator applications, the manipulator grips an object and performs a certain type of work on the object. At this time, if the manipulator applies excessive gripping forces to the object, then the object tends to be damaged. Conversely, if the manipulator fails to apply sufficient gripping forces to the object, then the object is likely to fall off the manipulator.

To prevent damage to the object or hold the object securely, it has been attempted in the art to combine the manipulator with a sensor for detecting the gripped state of the object that is being gripped by the manipulator. One type of such a sensor comprises a tactile sensor for detecting a perpendicular stress from the object as a gripping force of the manipulator and detecting a shear stress from the object as a slippage of the manipulator (see, for example, Japanese Laid-Open Patent Publication No. 2006-010407).

One tactile sensor of the type described above is an optical fiber sensor called “FBG (Fiber Bragg Grating) sensor” having a plurality of gratings (diffraction gratings) disposed in the core of an optical fiber embedded in a sheet body, as disclosed in Japanese Laid-Open Patent Publication No. 2002-131023 and Japanese Laid-Open Patent Publication No. 2002-071323. When a strain is developed in the gratings in response to a stress applied thereto from the object, the wavelength of a light beam reflected by the gratings is caused to change. Based on the changed wavelength, the optical fiber sensor detects the strain developed in the gratings and also detects the stress applied from the object.

However, the optical fiber sensor disclosed in Japanese Laid-Open Patent Publication No. 2002-131023 and Japanese Laid-Open Patent Publication No. 2002-071323 is problematic in that if the object gripped by the manipulator has a different shape or contacts the optical fiber at a different position, then a different stress distribution is produced on the gratings, making it difficult for the optical fiber sensor to detect the applied stress accurately.

FIG. 29 of the accompanying drawings is a schematic diagram showing a grating 1 disposed in an optical fiber 2 before and after a stress is applied to the grating 1 in a direction perpendicular to the direction in which the optical fiber 2 extends. When a stress F is applied substantially uniformly to the grating 1, the grating spaces of the grating 1 are expanded substantially uniformly. At this time, only the wavelength of a light beam reflected by the grating 1 is caused to change, as shown in FIG. 30 of the accompanying drawings.

However, if the manipulator grips an object having a different shape or grips an object at a different angle, then a stress tends to be applied nonuniformly to the grating 1. At this time, as shown in FIG. 31 of the accompanying drawings, the grating spaces of the grating 1 are expanded nonuniformly, i.e., the grating spaces vary at different positions. As a result, as shown in FIG. 32 of the accompanying drawings, the grating 1 reflects light beams of different wavelengths depending on the different expanded grating spaces thereof.

According to the solution proposed in Japanese Laid-Open Patent Publication No. 2005-134199, an optical fiber is inserted in a fixed layer which is sandwiched by elastic sheets, making up an FBG sensor section. The FBG sensor section has an end surface held in close contact with an object to be measured through an adhesive layer and an opposite end surface on which a pressing plate is disposed with a buffer layer interposed therebetween.

Even with the structure disclosed in Japanese Laid-Open Patent Publication No. 2005-134199, however, if the object gripped by the manipulator has a different shape or contacts the optical fiber at a different position, then a different stress distribution is produced on the pressing plate and hence the grating. Therefore, it is not easy to determine the exact magnitude of the applied stress, or stated otherwise, to achieve a sufficiently high level of measurement accuracy.

### SUMMARY OF THE INVENTION

It is a general object of the present invention to provide an optical fiber sensor which is highly durable and reliable.

A major object of the present invention is to provide an optical fiber sensor which serves as a tactile sensor for simultaneously detecting a perpendicular stress and a shearing stress that are applied from an object.

Another object of the present invention is to provide an optical fiber sensor which has an increased level of measurement accuracy for measuring stresses.

According to an aspect of the present invention, an optical fiber sensor comprises a plurality of shearing stress sensor sections including respective optical fibers and a plurality of gratings for reflecting light beams having predetermined wavelengths, the gratings being disposed in the optical fibers and arrayed along a plane parallel to the direction in which a shearing stress is applied from an object to the shearing stress sensor sections, and a perpendicular stress sensor section including an optical fiber and a pi urality of gratings for reflecting light beams having predetermined wavelengths, the gratings being disposed in the optical fiber and arrayed along a plane parallel to the direction in which a perpendicular stress is applied from the object to the perpendicular stress sensor section.

The optical fiber sensor thus constructed, which serves as a tactile sensor, is capable of independently and simultaneously detecting shearing and perpendicular stresses from the object based on optical signals from the optical fibers. Since the optical signals from the optical fibers are employed, the optical fiber sensor is not susceptible to electromagnetic noise. As the optical fiber sensor is free from possible electric leakage, the optical fiber sensor is highly durable and reliable and can detect shearing and perpendicular stresses highly accurately.

Each of the shearing stress sensor sections and the perpendicular stress sensor section should preferably comprise a flexible sheet body.

The optical fibers of the shearing stress sensor sections may extend respectively in two perpendicular directions in the plane parallel to the direction in which the shearing stress is applied from the object to the shearing stress sensor sections.

Alternatively, the gratings of the shearing stress sensor sections may be disposed in a plurality of different positions in the plane parallel to the direction in which the shearing stress is applied from the object to the shearing stress sensor sections, and the gratings may reflect respective light beams having different wavelengths.

Further alternatively, each of the shearing stress sensor sections may include two adjacent gratings, and detect the direction and magnitude of the shearing stress based on shift directions in and shift amounts by which the wavelengths of light beams reflected respectively by the two adjacent gratings are shifted.

The gratings of the perpendicular stress sensor section may be disposed in a plurality of different positions in the plane perpendicular to the direction in which the perpendicular stress is applied from the object to the perpendicular stress sensor section, and the gratings may reflect respective light beams having different wavelengths.

According to another aspect of the present invention, an optical fiber sensor comprises a stress sensor section including an optical fiber and a plurality of gratings for reflecting light beams having predetermined wavelengths, the gratings being disposed in the optical fiber, and stress direction converting means for converting the direction of an applied stress which is different from the longitudinal axis of the optical fiber into a direction parallel to the longitudinal axis of the optical fiber, and transmitting the stress to the gratings in the converted direction.

When the optical fiber is elongated by the stress direction converting means, the gratings disposed in the optical fiber are expanded so that the grating spaces are substantially uniform. This is because the optical fiber is elongated by the joints of the stress direction converting means which are joined to the optical fiber, and the applied stress is distributed substantially uniformly to the optical fiber.

After the gratings are expanded, therefore, the grating spaces are substantially uniform. Since shifts of the wavelengths of light beams reflected by the gratings are observed after the gratings are expanded, the stress acting on the optical fibers can be detected highly accurately based on the shifts of the wavelengths of the reflected light beams.

The stress direction converting means for converting the direction of the applied stress which is different from the longitudinal axis of the optical fiber into the direction parallel to the longitudinal axis of the optical fiber, are mounted on the optical fiber across each of the gratings in the optical fiber. The applied stress is distributed and applied to the joints between the optical fiber and the stress direction converting means.

As the grating spaces are substantially uniform after the gratings are expanded, shifts of the wavelengths of light beams reflected by the gratings are observed after the gratings are expanded. Therefore, the stress acting on the optical fiber can be detected highly accurately based on the shifts of the wavelengths of the reflected light beams.

The stress direction converting means comprises a flat portion extending parallel to the longitudinal axis of the optical fiber and a stress transmitter extending from the flat portion to the optical fiber.

Preferably, the flat portion has a higher modulus of elasticity than the stress transmitter. When the stress is applied, the flat portion is initially elongated. Then, as the flat portion is elongated, the stress transmitter is spread without being curved. Accordingly, the stress transmitter can easily elongate the optical fiber.

The above and other objects, features, and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1 is a schematic view, partly in block form, of a robot system incorporating an optical fiber sensor according to a first embodiment of the present invention;

FIG. 2 is a perspective view showing the operating principles of an FBG sensor;

FIG. 3 is a diagram showing the relationship between wavelengths of light applied to the FBG sensor and wavelengths of light beams reflected by gratings of the FBG sensor;

FIG. 4 is a view illustrative of the principles on which the FBG sensor detects a shearing stress;

FIG. 5 is a diagram showing the relationship between the wavelengths of light beams reflected by the gratings of the FBG sensor before and after a stress is applied as shown in FIG. 4;

FIG. 6 is a view illustrative of the principles on which the FBG sensor detects a shearing stress;

FIG. 7 is a diagram showing the relationship between the wavelengths of light beams reflected by the gratings of the FBG sensor before and after a stress is applied as shown in FIG. 6;

FIG. 8 is an exploded perspective view of the optical fiber sensor according to the first embodiment of the present invention;

FIG. 9 is a plan view of an X-direction shearing stress sensor section and a Y-direction shearing stress sensor section of the optical fiber sensor according to the first embodiment of the present invention;

FIG. 10 is a cross-sectional view of a Z-direction stress sensor section of the optical fiber sensor according to the first embodiment of the present invention;

FIG. 11 is a perspective view of a Z-direction stress sensor section according to another embodiment for use in the optical fiber sensor according to the first embodiment of the present invention;

FIG. 12 is a perspective view of a stacked assembly of the optical fiber sensor according to the first embodiment of the present invention;

FIG. 13 is a perspective view of a stacked assembly of an optical fiber sensor according to a second embodiment of the present invention;

FIG. 14 is a block diagram of the robot system which incorporates a tactile sensor in the form of the optical fiber sensor according to the first embodiment of the present invention;

FIG. 15 is a schematic view, partly in block form, of a robot system incorporating an optical fiber sensor according to a third embodiment of the present invention;

FIG. 16 is a perspective view showing the operating principles of an FBG sensor;

FIG. 17 is an exploded perspective view of the optical fiber sensor according to the third embodiment of the present invention;

FIG. 18 is a perspective view of two elastic members;

FIG. 19 is a block diagram of the robot system which incorporates the optical fiber sensor according to the third embodiment of the present invention;

FIG. 20 is a plan view showing how each of the elastic members changes its shape when a stress is applied to a substantially longitudinally central region of a flat portion of the elastic member;

FIG. 21 is a plan view showing how each of the elastic members changes its shape when a stress is applied to an end of the flat portion near a slanted portion of the elastic member;

FIG. 22 is a plan view showing the relationship between stresses applied to the flat portion, slanted portions, and joined portions of the elastic member;

FIG. 23 is a perspective view of other elastic members having a different shape;

FIG. 24 is a perspective view of still other elastic members having a different shape;

FIG. 25 is a perspective view of yet other elastic members having a different shape;

FIG. 26 is a perspective view of yet still other elastic members having a different shape;

FIG. 27 is a perspective view of further elastic members having a different shape;

FIG. 28 is a perspective view of still further elastic members having a different shape;

FIG. 29 is a schematic diagram showing a grating before and after a stress is applied to the grating in a direction perpendicular to the direction in which an optical fiber extends;

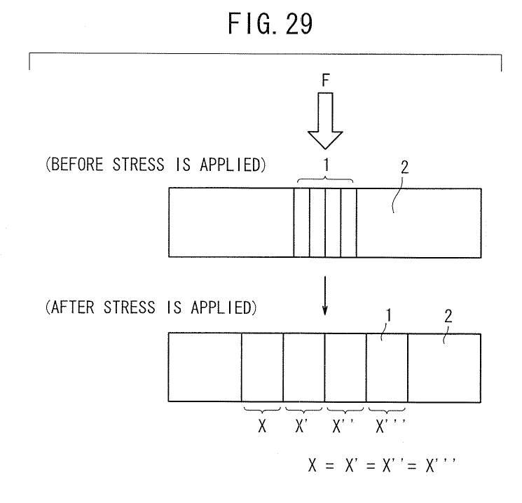

FIG. 30 is a diagram showing how the wavelength of a light beam reflected by the grating shown in FIG. 29 is caused to change;

FIG. 31 is a schematic diagram showing a grating before and after a stress is applied to the grating in a direction perpendicular to the direction in which an optical fiber extends; and

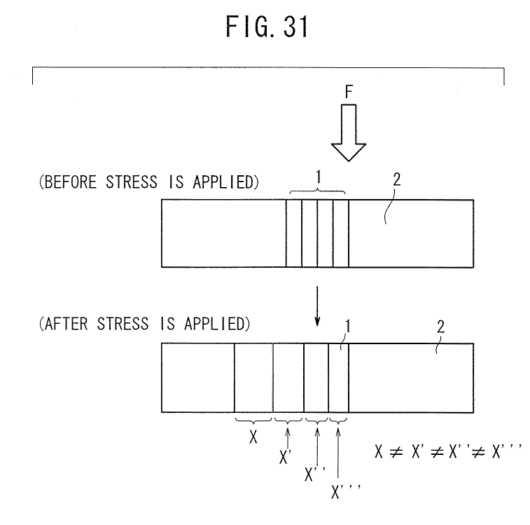

FIG. 32 is a diagram showing how the wavelength of a light beam reflected by the grating shown in FIG. 31 is caused to change.

### DESCRIPTION OF THE PREFERRED EMBODIMENTS

Optical fiber sensors according to preferred embodiments of the present invention will be described in detail below with reference to the accompanying drawings.

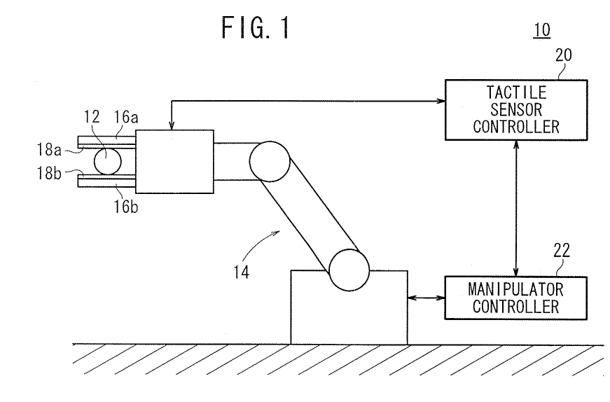

FIG. 1 schematically shows, partly in block form, a robot system 10 incorporating an optical fiber sensor (also hereinafter referred to as “tactile sensor”) according to a first embodiment of the present invention. As shown in FIG. 1, the robot system 10 comprises a manipulator 14 for gripping and handling an object 12, a pair of tactile sensors 18a, 18b disposed respectively on hands 16a, 16b of the manipulator 14 for detecting a gripped state of the object 12 gripped by the hands 16a, 16b while being held in contact with the object 12, a tactile sensor controller 20 for controlling the tactile sensors 18a, 18b to acquire shearing stresses and a perpendicular stress which serve as information representative of the gripped state of the object 12, and a manipulator controller 22 for controlling the manipulator 14 based on the shearing stresses and the perpendicular stress that have been acquired by the tactile sensor controller 20.

A slippage of the object 12 with respect to the hands 16a, 16b can be detected based on the shearing stresses that have been detected by the tactile sensors 18a, 18b when the hands 16a, 16b grip the object 12. A gripping force applied by the hands 16a, 16b to the object 12 can be detected based on the perpendicular stress that has been detected by the tactile sensors 18a, 18b when the hands 16a, 16b grip the object 12. Therefore, by controlling the hands 16a, 16b according to the shearing stresses and the perpendicular stress that have been detected, the robot system 10 can handle the object 12, e.g., grip the object 12 with an appropriate gripping force and move the object 12 to a desired position without letting the object 12 fall off.

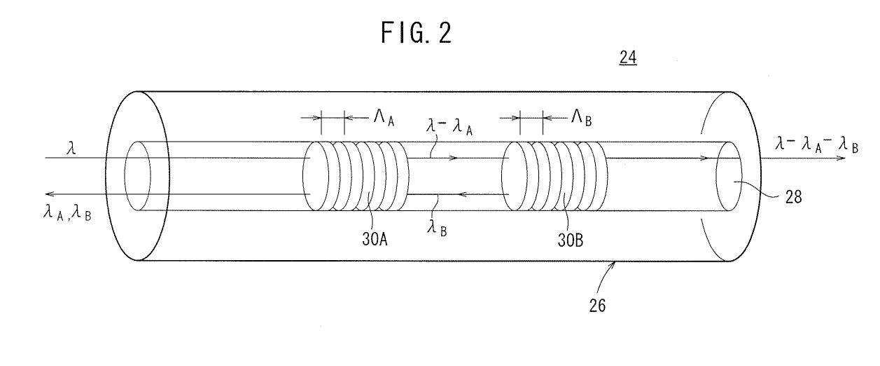

Each of the tactile sensors 18a, 18b comprises an FBG sensor 24 (see FIG. 2). The operating principles of the FBG sensor 24 will be described below with reference to FIG. 2.

The FBG sensor 24 comprises an optical fiber 26 having a core 28 and a plurality of gratings 30A, 30B formed in respective portions of the core 28 by ultraviolet rays. In FIG. 2, the FBG sensor 24 is shown as having two gratings 30A, 30B spaced from each other.

If it is assumed that the two gratings 30A, 30B have respective grating periods Λ_{A}, Λ_{B} and the core 28 has an effective refractive index n_{eff}, then the gratings 30A, 30B reflect light beams having respective wavelengths λ_{A}, λ_{B} (Bragg wavelengths) which satisfy the equations (1), (2) shown below, and pass light beams having other wavelengths.

λ_{A}=2n_{eff}Λ_{A} (1)

λ_{B}=2n_{eff}Λ_{B} (2)

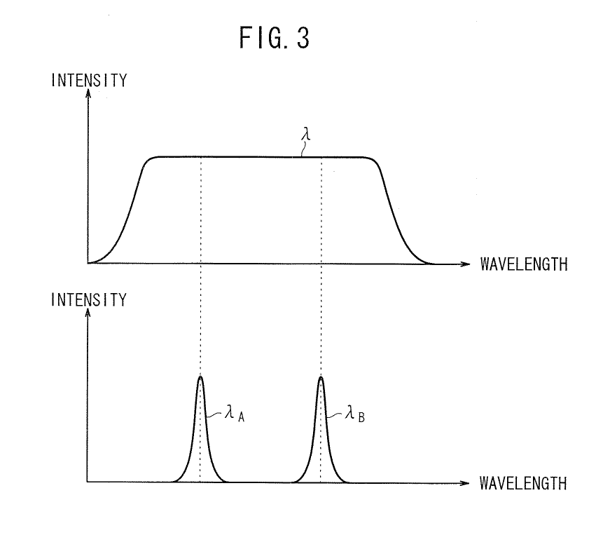

When light having a certain range of wavelengths λ shown in FIG. 3 is applied to an entrance end of the core 28 of the optical fiber 26, the optical fiber 26 emits reflected light beams having respective wavelengths Λ_{A}, Λ_{B} from the entrance end of the core 28 and emits light beams having other wavelengths from an opposite exit end of the core 28.

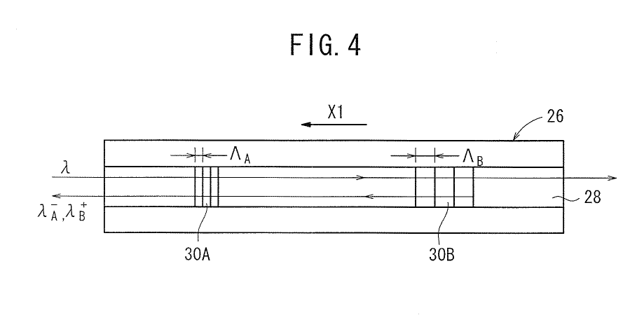

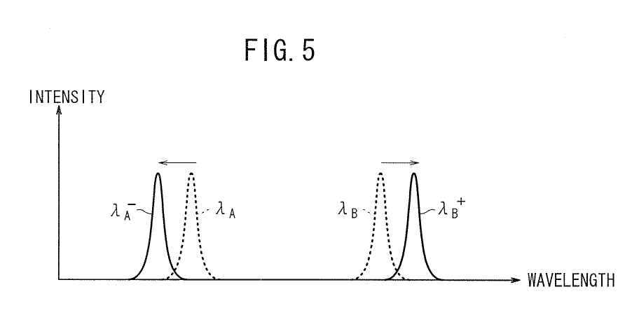

As shown in FIG. 4, when a shearing stress oriented in the direction indicated by the arrow X1 along the longitudinal axis of the optical fiber 26 is applied to the optical fiber 26 between the gratings 30A, 30B, the grating period Λ_{A} of the grating 30A is reduced, and the grating period Λ_{B} of the grating 30B is increased. Therefore, as shown in FIG. 5, the wavelength λ_{A} of the light beam reflected by the grating 30A is shifted to a wavelength λ_{A}⁻ which is shorter than the wavelength λ_{A}, and the wavelength λ_{B} of the light beam reflected by the grating 30B is shifted to a wavelength λ_{B}⁺ which is longer than the wavelength λ_{B}.

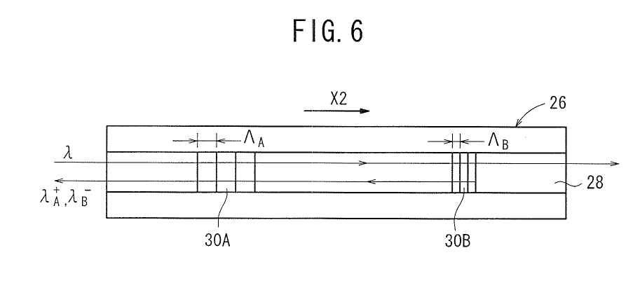

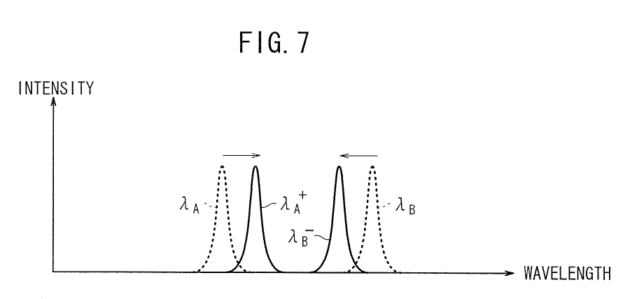

As shown in FIG. 6, when a shearing stress oriented in the direction indicated by the arrow X2 along the longitudinal axis of the optical fiber 26 is applied to the optical fiber 26 between the gratings 30A, 30B, the grating period Λ_{A} of the grating 30A is increased, and the grating period Λ_{B} of the grating 30B is reduced. Therefore, as shown in FIG. 7, the wavelength λ_{A} of the light beam reflected by the grating 30A is shifted to a wavelength λ_{A}⁺ which is longer than the wavelength λ_{A}, and the wavelength λ_{B} of the light beam reflected by the grating 30B is shifted to a wavelength λ_{B}⁻ which is shorter than the wavelength λ_{B}.

Consequently, the direction and magnitude of the applied shearing stress can be determined by detecting the shift directions in and the shift amounts by which the wavelengths λ_{A}, λ_{B} of the light beams reflected by adjacent gratings 30A, 30B are shifted.

The magnitude of a stress applied longitudinally to the optical fiber 26, i.e., a perpendicular stress, can be determined by detecting the shift amount by which the wavelength λ_{A} or λ_{B} of the light beam reflected by the grating 30A or 30B is shifted.

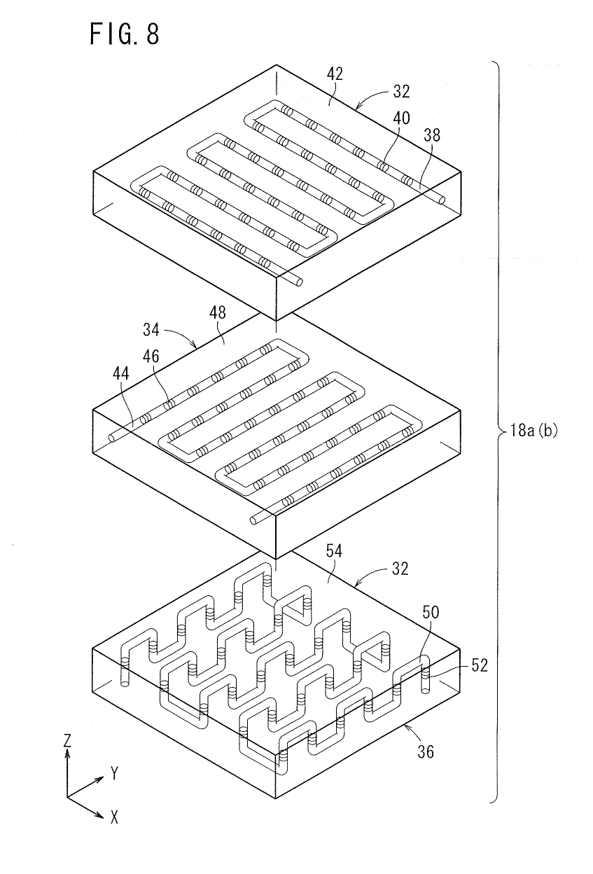

FIG. 8 shows in exploded perspective the tactile sensors 18a, 18b each in the form of the FBG sensor 24 shown in FIG. 2.

As shown in FIG. 8, each of the tactile sensors 18a, 18b comprises an X-direction shearing stress sensor section 32 for detecting a shearing stress applied in an X-axis direction of an orthogonal three-axis coordinate system, a Y-direction shearing stress sensor section 34 for detecting a shearing stress applied in a Y-axis direction of the orthogonal three-axis coordinate system, and a Z-direction stress sensor section 36 for detecting a perpendicular stress applied in a Z-axis direction of the orthogonal three-axis coordinate system.

The X-direction shearing stress sensor section 32 is in the form of a sheet body including a single optical fiber 38 which has a number of gratings 40 disposed therein at regular intervals in the longitudinal direction of the optical fiber 38 and arrayed along the X-axis direction, and a flexible pressure-sensitive member 42 of plastic, resin, or the like, the optical fiber 38 being encased in the flexible pressure-sensitive member 42 which is molded. The gratings 40 have respective grating periods (see the grating periods Λ_{A}, Λ_{B} shown in FIG. 2) which are different from each other.

The Y-direction shearing stress sensor section 34 is in the form of a sheet body including a single optical fiber 44 which has a number of gratings 46 disposed therein at regular intervals in the longitudinal direction of the optical fiber 44 and arrayed along the Y-axis direction, and a flexible pressure-sensitive member 48 of plastic, resin, or the like, the optical fiber 44 being encased in the flexible pressure-sensitive member 48 which is molded. The gratings 46 have respective grating periods (see the grating periods Λ_{A}, Λ_{B} shown in FIG. 2) which are different from each other.

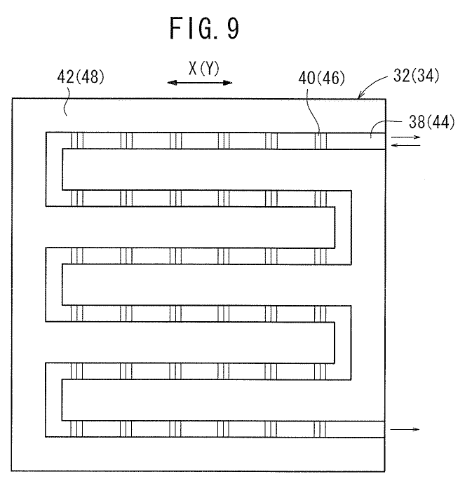

FIG. 9 shows in plan the X-direction shearing stress sensor section 32 and the Y-direction shearing stress sensor section 34.

The Z-direction stress sensor section 36 is in the form of a sheet body including a single optical fiber 50 which has a number of gratings 52 disposed therein at regular intervals in the longitudinal direction of the optical fiber 50 and arrayed in the Z-axis direction, and a flexible pressure-sensitive member 54 of plastic, resin, or the like, the optical fiber 50 being encased in the flexible pressure-sensitive member 54 which is molded. The gratings 52 have respective grating periods (see the grating periods Λ_{A}, Λ_{B} shown in FIG. 2) which are different from each other.

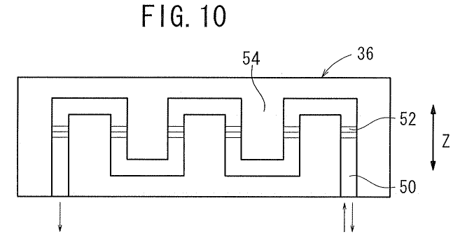

FIG. 10 shows the Z-direction stress sensor section 36 in cross section taken along a Y-Z plane.

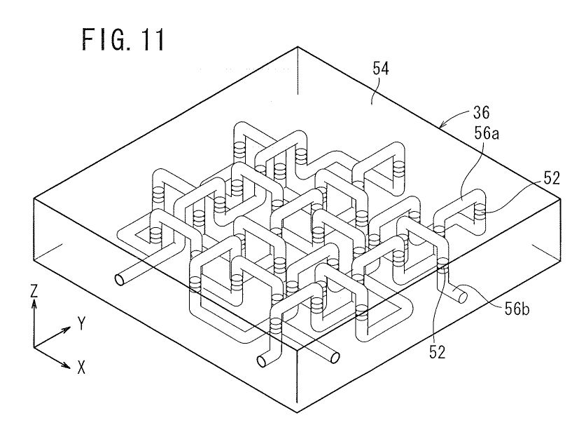

As shown in FIG. 11, the Z-direction stress sensor section 36 may include two optical fibers 56a, 56b combined in a staggered pattern perpendicularly to each other so that the gratings 52 in the optical fibers 56a, 56b are packaged in an increased density in the Z-direction stress sensor section 36.

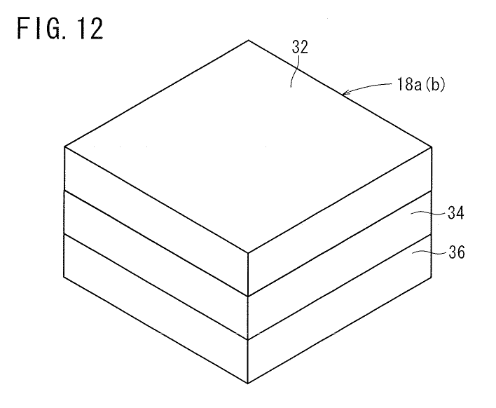

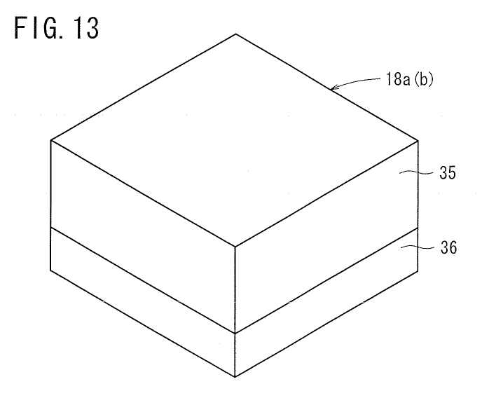

As shown in FIG. 12, each of the tactile sensors 18a, 18b may comprise a stacked assembly of the X-direction shearing stress sensor section 32, the Y-direction shearing stress sensor section 34, and the Z-direction stress sensor section 36. Alternatively, according to a second embodiment of the present invention as shown in FIG. 13, each of the tactile sensors 18a, 18b may comprise a stacked assembly of a shearing stress sensor section 35 which is an integral combination of the X-direction shearing stress sensor section 32 and the Y-direction shearing stress sensor section 34, and the Z-direction stress sensor section 36.

As the tactile sensors 18a, 18b are in the form of the flexible sheet bodies of the X-direction shearing stress sensor section 32, the Y-direction shearing stress sensor section 34, and the Z-direction stress sensor section 36, the tactile sensors 18a, 18b can be installed on the surfaces of the hands 16a, 16b which may be of any desired shapes.

The X-direction shearing stress sensor section 32, the Y-direction shearing stress sensor section 34, and the Z-direction stress sensor section 36 include the respective single optical fibers 38, 44, 50. However, each of the optical fibers 38, 44, 50 may comprise a plurality of optical fibers including gratings.

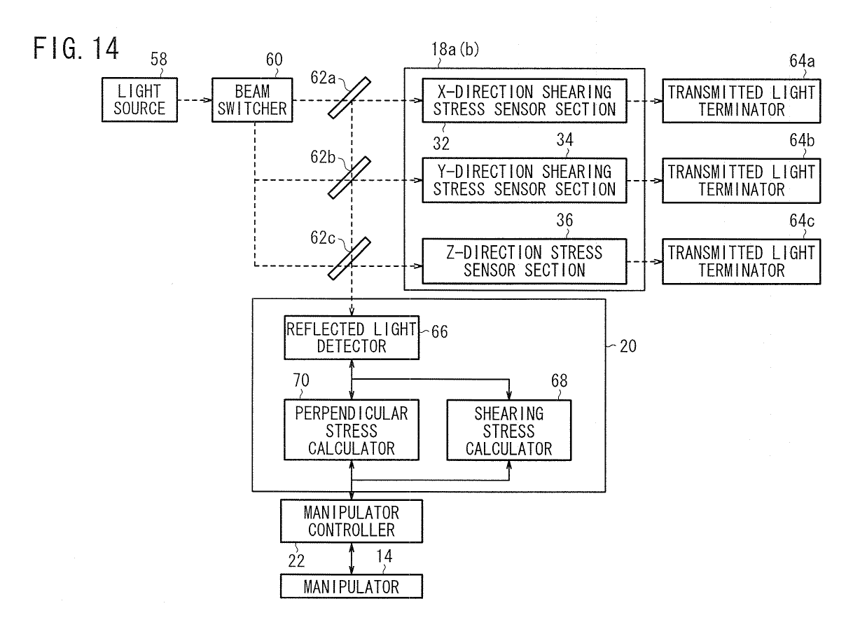

FIG. 14 shows in block form the robot systems 10 incorporating the tactile sensors 18a, 18b of the above structure.

As shown in FIG. 14, light emitted from a light source 58 is supplied to the X-direction shearing stress sensor section 32, the Y-direction shearing stress sensor section 34, or the Z-direction stress sensor section 36 of each of the tactile sensors 18a, 18b by one of half-silvered mirrors 62a, 62b, 62c which is selected by a beam switcher 60 in a time-sharing fashion.

The light enters the optical fiber 38, 44, or 50 (see FIG. 8) of the X-direction shearing stress sensor section 32, the Y-direction shearing stress sensor section 34, or the Z-direction stress sensor section 36 from one end thereof. Part of the light is reflected by the gratings 40, 46, or 52, and the remaining light passes through the gratings 40, 46, or 52 to a transmitted light terminator 64a, 64b, or 64c.

The light beams reflected by the gratings 40, 46, or 52 are guided by the half-silvered mirror 62a, 62b, or 62c to a reflected light detector 66 of the tactile sensor controller 20, which detects and converts the light beams into electric signals. The reflected light detector 66 comprises a spectroscope for spectroscoping and detecting applied light beams of respective wavelengths. Electric signals converted from the light beams reflected from the X-direction shearing stress sensor section 32 and the Y-direction shearing stress sensor section 34 are supplied to a shearing stress calculator 68, and electric signals converted from the light beams reflected from the Z-direction stress sensor section 36 are supplied to a perpendicular stress calculator 70.

Based on the electric signals converted from the light beams reflected from the gratings 40 of the X-direction shearing stress sensor section 32 and according to the shift amounts and the shift directions of the wavelengths of the light beams reflected from adjacent gratings 40, the shearing stress calculator 68 calculates the magnitude and direction of a shearing stress applied to the X-direction shearing stress sensor section 32 at a position corresponding to the adjacent gratings 40, as shown in FIGS. 5 and 7. Similarly, based on the electric signals converted from the light beams reflected from the gratings 46 of the Y-direction shearing stress sensor section 34 and according to the shift amounts and the shift directions of the wavelengths of the light beams reflected from adjacent gratings 46, the shearing stress calculator 68 calculates the magnitude and direction of a shearing stress applied to the Y-direction shearing stress sensor section 34 at each position corresponding to the adjacent gratings 46. A slippage of the object 12 in an X-Y plane with respect to the hands 16a, 16b can be detected from the calculated magnitudes and directions.

Since the gratings 40, 46 are arranged in a two-dimensional matrix in the X-Y plane, the shearing stress calculator 68 can determine a slippage distribution in the X-Y plane based on the slippages detected through the gratings 40, 46 and positional information of the gratings 40, 46.

Based on the electric signals converted from the light beams reflected from the gratings 52 of the Z-direction stress sensor section 36 and according to the shift amounts of the wavelengths of the light beams reflected from each grating 52 of the Z-direction stress sensor section 36, the perpendicular stress calculator 70 calculates the magnitude of a perpendicular stress applied to the Z-direction stress sensor section 36 at each position corresponding to the grating 52. A gripping force applied to the object 12 by the hands 16a, 16b in the Z-axis direction can be detected from the calculated magnitude of the perpendicular stress. Since the gratings 52 are arranged in a two-dimensional matrix in the X-Y plane, the perpendicular stress calculator 70 can determine a gripping force distribution in the X-Y plane based on the gripping forces detected through the gratings 52 and positional information of the gratings 52.

In the robot system 10 shown in FIG. 14, the light emitted from the light source 58 is supplied to the tactile sensors 18a, 18b from one of half-silvered mirrors 62a, 62b, 62c which is selected by the beam switcher 60 in a time-sharing fashion, and the reflected light beams from the tactile sensors 18a, 18b are detected by the reflected light detector 66. However, the X-direction shearing stress sensor section 32, the Y-direction shearing stress sensor section 34, and the Z-direction stress sensor section 36 of the tactile sensors 18a, 18b may be supplied with respective light beams from three independent light sources, and reflected light beams from the X-direction shearing stress sensor section 32, the Y-direction shearing stress sensor section 34, and the Z-direction stress sensor section 36 may be detected by three independent reflected light detectors. According to such a modification, it is possible to simultaneously detect shearing and perpendicular stresses applied from the object 12.

The tactile sensors 18a, 18b are not limited to detecting a gripped state of the object 12 gripped by the hands 16a, 16b, but are also applicable to the detection of a surface state of an object, for example.

An optical fiber sensor according to a third embodiment of the present invention will be described in detail below.

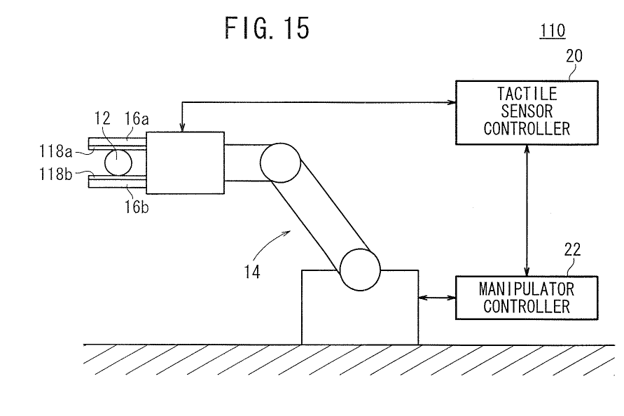

FIG. 15 schematically shows, partly in block form, a robot system 110 incorporating the optical fiber sensor according to the third embodiment of the present invention. As shown in FIG. 15, the robot system 110 comprises a manipulator 14 for gripping and handling an object 12, a pair of optical fiber sensors 118a, 118b disposed respectively on hands 16a, 16b of the manipulator 14 for detecting a gripped state of the object 12 gripped by the hands 16a, 16b while being held in contact with the object 12, an optical fiber sensor controller 20 for controlling the optical fiber sensors 118a, 118b to acquire shearing stresses and a perpendicular stress which serve as information representative of the gripped state of the object 12, and a manipulator controller 22 for controlling the manipulator 14 based on the shearing stresses and the perpendicular stress that have been acquired by the optical fiber sensor controller 20.

Slippages of the object 12 with respect to the hands 16a, 16b can be detected based on the shearing stresses detected by the optical fiber sensors 118a, 118b when the hands 16a, 16b grip the object 12. A gripping force applied to the object 12 by the hands 16a, 16b can be detected based on the perpendicular stress that has been detected by the optical fiber sensors 118a, 118b when the hands 16a, 16b grip the object 12. Therefore, by controlling the hands 16a, 16b according to the shearing stresses and the perpendicular stress that have been detected, the robot system 110 can handle the object 12, e.g., grip the object 12 with an appropriate gripping force and move the object 12 to a desired position without letting the object 12 fall off.

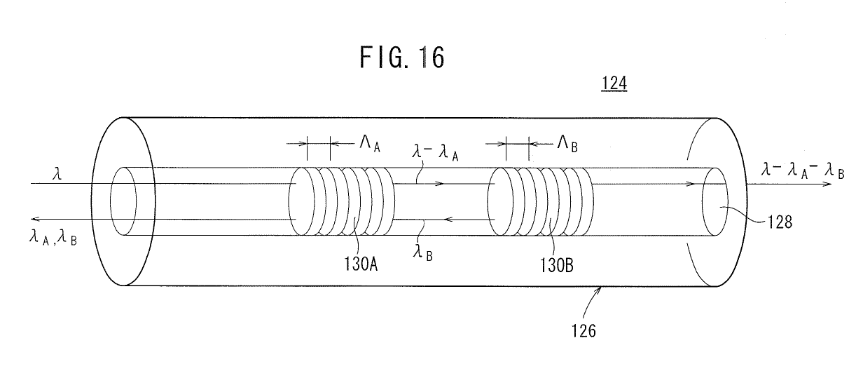

Each of the optical fiber sensors 118a, 118b comprises an FBG sensor 124 shown in FIG. 16. The FBG sensor 124 is essentially identical in structure to the FBG sensor 24 shown in FIG. 2, and the operating principles of the FBG sensor 124 are also essentially the same as the operating principles of the FBG sensor 24. Thus, descriptions of the operating principles are omitted. In FIG. 16, the FBG sensor 124 includes an optical fiber 126 having a core 128 and a pair of gratings 130A, 130B disposed in portions of the core 128.

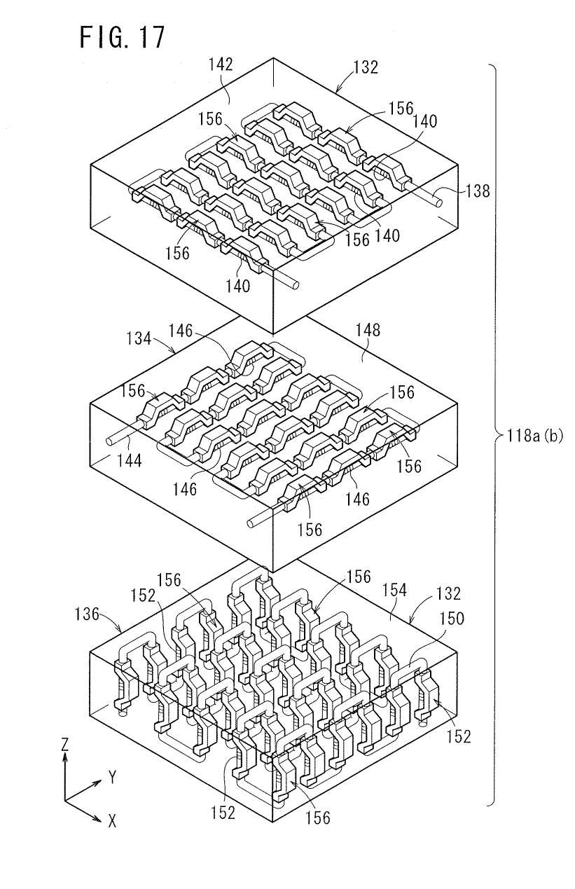

FIG. 17 shows in exploded perspective each of the optical fiber sensors 118a, 118b utilizing the FBG sensor 124 shown in FIG. 16.

Each of the optical fiber sensors 118a, 118b comprises an X-direction shearing stress sensor section 132 for detecting a shearing stress applied in an X-axis direction of an orthogonal three-axis coordinate system, a Y-direction shearing stress sensor section 134 for detecting a shearing stress applied in a Y-axis direction of the orthogonal three-axis coordinate system, and a Z-direction stress sensor section 136 for detecting a perpendicular stress applied in a Z-axis direction of the orthogonal three-axis coordinate system.

The X-direction shearing stress sensor section 132 is in the form of a sheet body including a single optical fiber 138 which has a number of gratings 140 disposed therein at regular intervals in the longitudinal direction of the optical fiber 138 and arrayed in the X-axis direction, and a flexible pressure-sensitive member 142 of plastic, resin, or the like, the optical fiber 138 being encased in the flexible pressure-sensitive member 142 which is molded. The gratings 140 have respective grating periods (see the grating periods Λ_{A}, Λ_{B} shown in FIG. 16) which are different from each other.

The Y-direction shearing stress sensor section 134 is in the form of a sheet body including a single optical fiber 144 which has a number of gratings 146 disposed therein at regular intervals in the longitudinal direction of the optical fiber 144 and arrayed in the Y-axis direction, and a flexible pressure-sensitive member 148 of plastic, resin, or the like, the optical fiber 144 being encased in the flexible pressure-sensitive member 148 which is molded. The gratings 146 have respective grating periods (see the grating periods Λ_{A}, Λ_{B} shown in FIG. 16) which are different from each other.

The Z-direction stress sensor section 136 is in the form of a sheet body including a single optical fiber 150 which has a number of gratings 152 disposed therein at regular intervals in the longitudinal direction of the optical fiber 150 and arrayed in the Z-axis direction, and a flexible pressure-sensitive member 154 of plastic, resin, or the like, the optical fiber 150 being encased in the flexible pressure-sensitive member 154 which is molded. The gratings 152 have respective grating periods (see the grating periods Λ_{A}, Λ_{B} shown in FIG. 16) which are different from each other.

As the optical fiber sensors 118a, 118b are in the form of the flexible sheet bodies of the X-direction shearing stress sensor section 132, the Y-direction shearing stress sensor section 134, and the Z-direction stress sensor section 136, the optical fiber sensors 118a, 118b can be installed on the surfaces of the hands 16a, 16b which may be of any desired shapes.

The X-direction shearing stress sensor section 132, the Y-direction shearing stress sensor section 134, and the Z-direction stress sensor section 136 include the respective single optical fibers 138, 144, 150. However, each of the optical fibers 138, 144, 150 may comprise a plurality of optical fibers including gratings.

Elastic members 156 which serve as a stress direction converting means are mounted on the optical fibers 138, 144, 150 over and across the respective gratings 140, 146, 152.

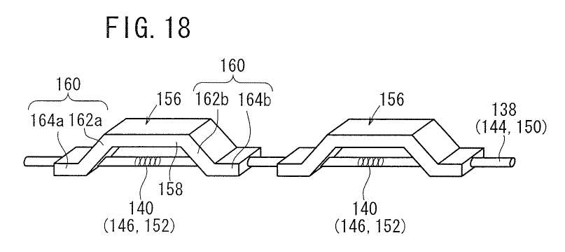

FIG. 18 shows in perspective the optical fiber 138, for example, with two elastic members 156 mounted thereon. As shown in FIG. 18, each of the elastic members 156 comprises a flat portion 158 extending parallel to the longitudinal axis of the optical fiber 138, and a stress transmitter 160 extending from the opposite ends of the flat portion 158 to the respective ends of the grating 140. The stress transmitter 160 comprises a pair of slanted portions 162a, 162b joined to the respective opposite ends of the flat portion 158 and extending obliquely to the optical fiber 138, and a pair of joints 164a, 164b joined to the distal ends of the respective slanted portions 162a, 162b and surrounding the optical fiber 138. The slanted portion 162a and the joint 164a are inclined to each other through an angle θ1, and the slanted portion 162b and the joint 164b are inclined to each other through an angle θ2 which is equal to the angle θ1.

The elastic members 156 may be made of any of various elastically deformable materials. Preferable elastically deformable materials include rubber or resin. The elastic members 156 may also be made of liquid crystal polymer, carbon-fiber-reinforced plastic (CFRP), or the like. It is preferable that the flat portion 158 have a higher modulus of elasticity than the slanted portions 162a, 162b and the joints 164a, 164b.

The elastic members 156 mounted on the other optical fibers 144, 150 are identical in structure to the elastic members 156 mounted on the optical fiber 138.

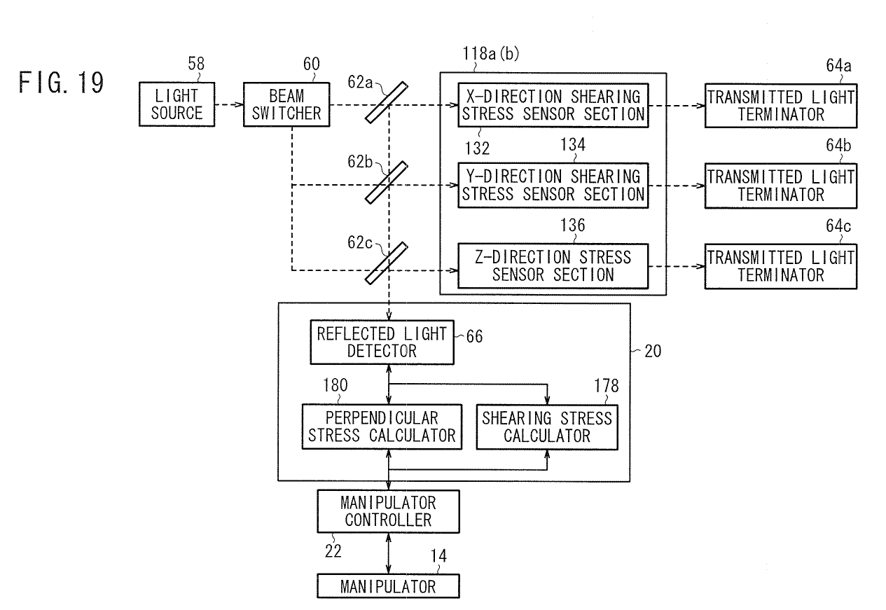

FIG. 19 shows in block form the robot systems 110 incorporating the optical fiber sensors 118a, 118b of the above structure.

As shown in FIG. 19, light emitted from a light source 58 is supplied to the X-direction shearing stress sensor section 132, the Y-direction shearing stress sensor section 134, or the Z-direction stress sensor section 136 of each of the optical fiber sensors 118a, 118b by one of half-silvered mirrors 62a, 62b, 62c which is selected by a beam switcher 60 in a time-sharing fashion.

The light enters the optical fiber 138, 144, or 150 (see FIG. 17) of the X-direction shearing stress sensor section 132, the Y-direction shearing stress sensor section 134, or the Z-direction stress sensor section 136 from one end thereof. Part of the light is reflected by the gratings 140, 146, or 152, and the remaining light passes through the gratings 140, 146, or 152 to a transmitted light terminator 64a, 64b, or 64c.

The light beams reflected by the gratings 140, 146, or 152 are guided by the half-silvered mirror 62a, 62b, or 62c to a reflected light detector 66 of the optical fiber sensor controller 20, which detects and converts the light beams into electric signals. The reflected light detector 66 comprises a spectroscope for spectroscoping and detecting applied light beams of respective wavelengths. Electric signals converted from the light beams reflected from the X-direction shearing stress sensor section 132 and the Y-direction shearing stress sensor section 134 are supplied to a shearing stress calculator 178, and electric signals converted from the light beams reflected from the Z-direction stress sensor section 136 are supplied to a perpendicular stress calculator 180.

Based on the electric signals converted from the light beams reflected from the gratings 140 of the X-direction shearing stress sensor section 132 and according to the shift amounts and the shift directions of the wavelengths of the light beams reflected from adjacent gratings 140, the shearing stress calculator 178 calculates the magnitude and direction of a shearing stress applied to the X-direction shearing stress sensor section 132 at each position corresponding to the adjacent gratings 140, as with the case in FIGS. 5 and 7. Similarly, based on the electric signals converted from the light beams reflected from the gratings 140 of the Y-direction shearing stress sensor section 134 and according to the shift amounts and the shift directions of the wavelengths of the light beams reflected from adjacent gratings 146, the shearing stress calculator 178 calculates the magnitude and direction of a shearing stress applied to the Y-direction shearing stress sensor section 134 at each position corresponding to the adjacent gratings 146. A slippage of the object 12 in an X-Y plane with respect to the hands 16a, 16b can be detected from the calculated magnitudes and directions.

Since the gratings 140, 146 are arranged in a two-dimensional matrix in the X-Y plane, the shearing stress calculator 178 can determine a slippage distribution in the X-Y plane based on the slippages detected through the gratings 140, 146 and positional information of the gratings 140, 146.

Based on the electric signals converted from the light beams reflected from the gratings 152 of the Z-direction stress sensor section 136 and according to the shift amounts of the wavelengths of the light beams reflected from each grating 152 of the Z-direction stress sensor section 136, the perpendicular stress calculator 180 calculates the magnitude of a perpendicular stress applied to the Z-direction stress sensor section 136 at each position corresponding the grating 52. A gripping force applied to the object 12 by the hands 16a, 16b in the Z-axis direction can be detected from the calculated magnitude of the perpendicular stress. Since the gratings 152 are arranged in a two-dimensional matrix in the X-Y plane, the perpendicular stress calculator 180 can determine a gripping force distribution in the X-Y plane based on the gripping force detected through the gratings 152 and positional information of the gratings 152.

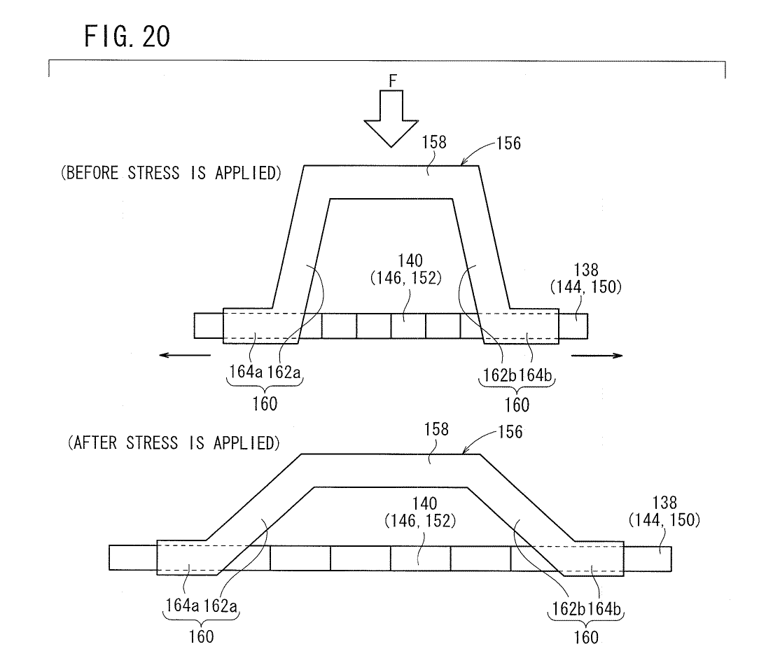

As shown in FIG. 20, when a shearing stress F is applied to the elastic member 156 on the optical fiber 138 or 144, the shearing stress initially acts on the flat portion 158 of the elastic member 156, elongating the flat portion 158.

As described above, the moduli of elasticity of the slanted portions 162a, 162b and the joints 164a, 164b are lower than the modulus of elasticity of the flat portion 158. Therefore, the slanted portions 162a, 162b are angularly moved away from each other about their junctions to the flat portion 158, thereby increasing the angles formed between the flat portion 158 and the slanted portions 162a, 162b. Stated otherwise, the slanted portions 162a, 162b are spread away from each other, thereby displacing the joints 164a, 164b away from each other. As a result, the angles formed between the slanted portions 162a, 162b and the joints 164a, 164b are reduced.

As the joints 164a, 164b are displaced away from each other, the optical fiber 138 or 144 is elongated along its longitudinal axis, thereby expanding the grating period of the grating 140 or 146. The thus-expanded grating period is also substantially uniform along the longitudinal axis of the optical fiber 138 or 144, because the optical fiber 138 or 144 is elongated along its longitudinal axis by both joints 164a, 164b displaced away from each other.

Accordingly, the elastic member 156 serves to convert the direction of the applied shearing stress from a direction substantially perpendicular to the longitudinal axis of the optical fiber 138 or 144 to a direction parallel to the longitudinal axis of the optical fiber 138 or 144.

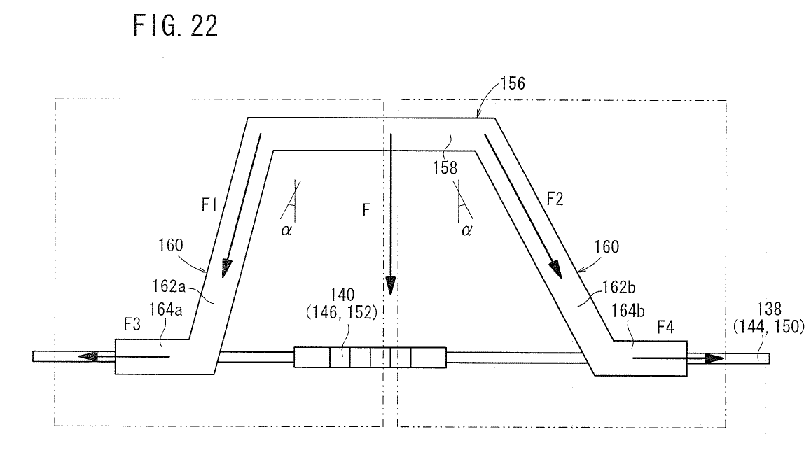

As shown in FIG. 22, if it is assumed that when the shearing stress F is applied to the elastic member 156, stresses F1, F2 act respectively on the slanted portions 162a, 162b, and stresses F3, F4 act respectively on the joints 164a, 164b, then the gratings 140, 146 are expanded by forces F3, F4 which are equal to the stresses F3, F4, respectively. If the angles formed between the direction in which the shearing stress F acts and the slanted portions 162a, 162b are represented by α, then the shearing stress F, the stresses F1, F2 and the angles a satisfy the following equation (3):

F1=F2=F cos α (3)

Since the angle formed between the direction of the stress F2 and the longitudinal axis of the optical fiber 138 or 144 is represented by 90°−α, the forces F3, F4 acting on the optical fiber 138 or 144 and the joints 164a, 164b are expressed by the following equation (4):

$$\begin{matrix}F 3 = F 4 \\ = F 2 cos ( 90 ° - α ) \\ = F 2 sin α \\ = F cos αsinα\end{matrix} \qquad ( 4 )$$

Since the angle θ1 formed between the slanted portion 162a and the joint 164a and the angle θ2 formed between the slanted portion 162b and the joint 164b are equal to each other, the stress F1 is equal to the stress F2 and the force F3 is equal to the force F4. If it is assumed that the optical fiber 138 or 144 has an elastic constant E and a strain ε, then the following equation (5) is satisfied:

ε=(2/E)F cos α sin α (5)

If it is assumed that the grating number of the grating 140 or 146 is represented by N and a variation in the grating space of the grating 140 or 146 is represented by A, then the grating number N and the grating space Δ satisfy the following equation (6):

Δ=ε/(N−1) (6)

By assigning the equation (5) to ε in the equation (6), the equation (6) is expressed according to the following equation (7):

Δ=2F cos α sin α/[E×(N−1)] (7)

Therefore, the wavelength shift λ can be determined by the following equation (8):

$$\begin{matrix}λ = 2 \times {n}_{eff} \times Δ \\ = 4 \times {n}_{eff} \times F cos α sin α / [ E \times ( N - 1 ) ]\end{matrix} \qquad ( 8 )$$

A peak waveform is thus uniquely determined depending on the shearing stress F.

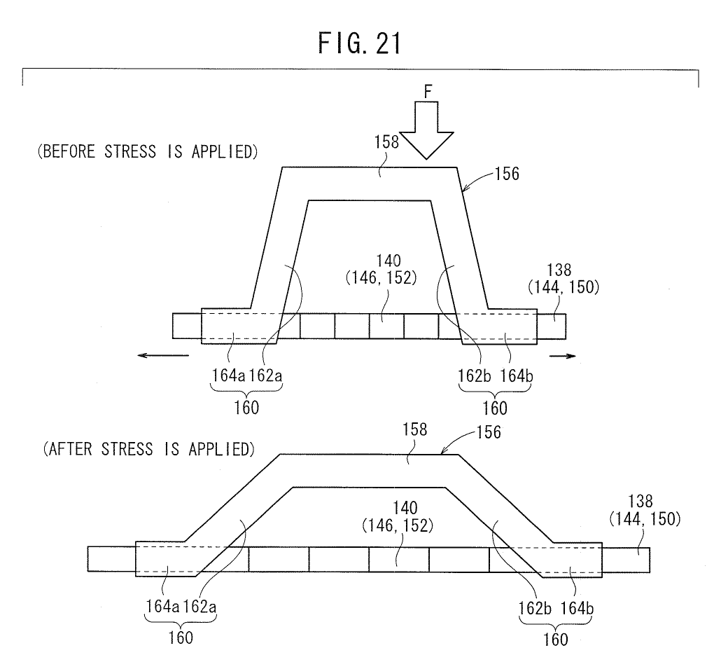

The phenomenon referred to above also occurs when the shearing stress is applied to the flat portion 158 at a position that is displaced off the longitudinally central position of the flat portion 158, e.g., when the shearing stress is applied to the end of the flat portion 158 near the slanted portion 162b, as shown in FIG. 21. Specifically, when the shearing stress is applied to the end of the flat portion 158 near the slanted portion 162b, the flat portion 158 is elongated toward the slanted portion 162a. The slanted portions 162a, 162b are angularly moved away from each other, thereby displacing the joints 164a, 164b away from each other. As a result, the optical fiber 138 or 144 is elongated, expanding the grating spaces of the grating 140 or 146. As shown in FIG. 21, the grating spaces of the grating 140 or 146 are substantially equally expanded.

Although not shown, the above phenomenon also occurs when the shearing stress is applied to the end of the flat portion 158 near the slanted portion 162a.

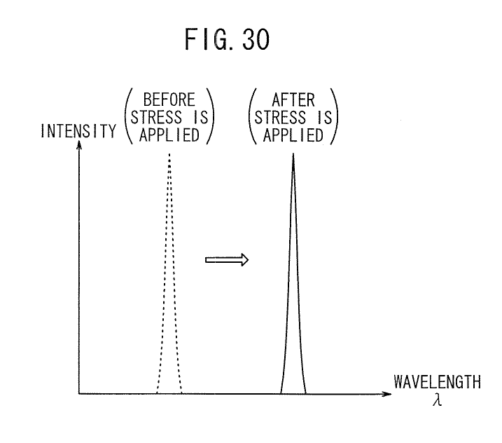

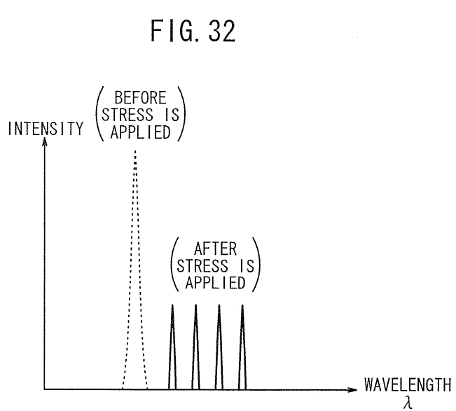

Since the grating 140 or 146 is expanded such that the grating spaces are substantially equally expanded, the grating 140 or 146 does not reflect a plurality of light beams having different wavelengths (see FIG. 32), but reflect a light beam having a wavelength which is different from the wavelength of the light beam that is reflected before the grating 140 or 146 is expanded, as shown in FIG. 30.

If the angle θ1 formed between the slanted portion 162a and the joint 164a and the angle θ2 formed between the slanted portion 162b and the joint 164b are different from each other, then the following calculations may be performed:

If it is assumed that the angles formed between the direction in which the shearing stress F acts and the slanted portions 162a, 162b are represented by α, β, respectively, and the slanted portions 162a, 162b have respective strains ε1, ε2, then the following equations (9), (10) are satisfied:

$$\begin{matrix}\begin{matrix}ɛ 1 = F 3 / E \\ = F cos α sin α / E\end{matrix} & ( 9 ) \\ \begin{matrix}ɛ 2 = F 4 / E \\ = F cos β sin β / E\end{matrix} & ( 10 )\end{matrix}$$

Inasmuch as the total strain ε is equal to ε1+ε2, the following equation (11) is satisfied:

$$\begin{matrix}ɛ = ɛ 1 + ɛ 2 \\ = ( F cos α sin α + F cos β sin β ) / E\end{matrix} \qquad ( 11 )$$

By assigning the equation (11) to ε in the equation (6), the equation (6) is expressed according to the following equation (12):

Δ=(F cos α sin α+F cos β sin β)/[ε×(N−1)] (12)

Therefore, the wavelength shift ε can be determined by the following equation (13):

$$\begin{matrix}λ = 2 \times {n}_{eff} \times Δ \\ = 2 \times {n}_{eff} \times ( F cos α sin α + F cos β sin β ) / [ E \times ( N - 1 ) ]\end{matrix} \qquad ( 13 )$$

The optical fiber sensor according to the third embodiment operates in the same manner as described above when a perpendicular stress is applied to the optical fiber 150. A peak waveform depending on the perpendicular stress is determined according to equations similar to the above equations (4) through (13).

According to the third embodiment, as described above, when the gratings 140, 146, 152 are expanded, the respective grating spaces are substantially uniformly expanded, and the wavelength that is shifted is uniquely determined depending on the applied stress. Consequently, the applied stress can be measured with increased accuracy.

Although certain preferred embodiments of the present invention have been shown and described in detail, it should be understood that various changes and modifications may be made therein without departing from the scope of the appended claims.

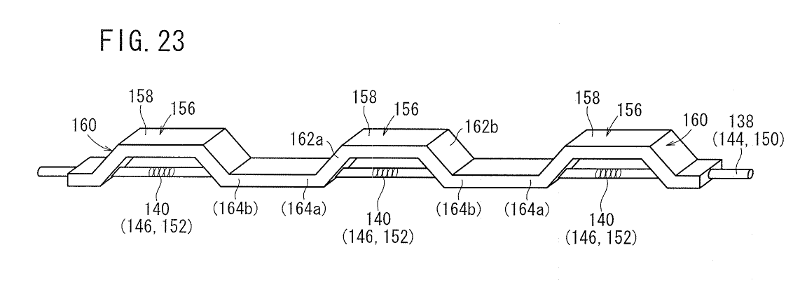

For example, FIG. 23 shows in perspective other elastic members 156, which serve as a stress direction converting means, having a different shape. As shown in FIG. 23, each of the elastic members 156 has joints 164a, 164b which are joined to joints 164b, 164a of adjacent elastic members 156.

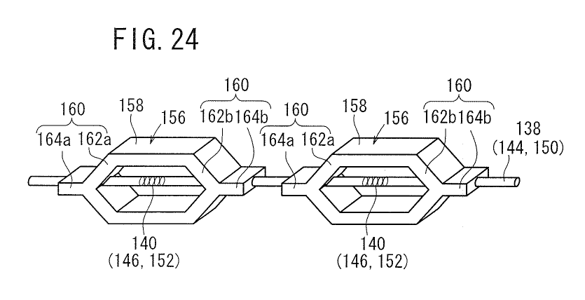

FIG. 24 shows in perspective still other elastic members 156 having a different shape. As shown in FIG. 24, each of the elastic members 156 surrounds upper and lower surfaces of the optical fiber 138, 144, or 150.

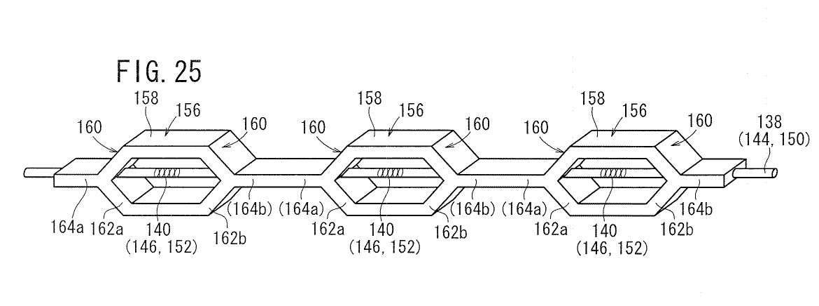

FIG. 25 shows in perspective yet other elastic members 156 having a different shape. As shown in FIG. 25, each of the elastic members 156, which are similar to the elastic members 156 shown in FIG. 24, has joints 164a, 164b which are joined to joints 164b, 164a of adjacent elastic members 156.

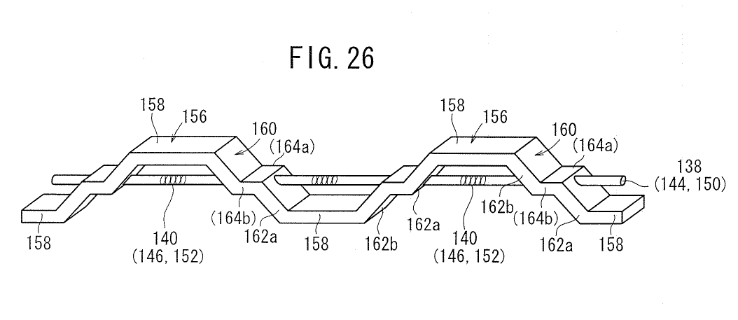

FIG. 26 shows in perspective yet still other elastic members 156 having a different shape. As shown in FIG. 26, each of the elastic members 156 is disposed over or under the optical fiber 138, 144, or 150, and has joints 164a, 164b which are joined to joints 164b, 164a of adjacent elastic members 156.

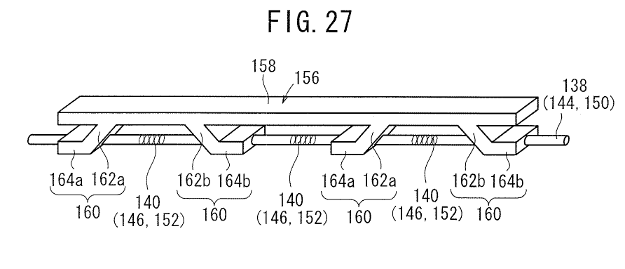

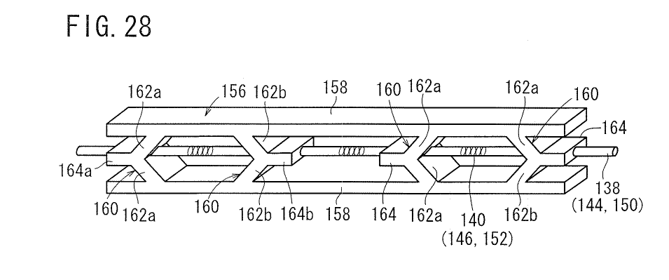

FIGS. 27 and 28 show in perspective further elastic members 156 having different shapes. As shown in FIGS. 27 and 28, adjacent ones of the elastic members 156 have respective flat portions 158 joined to each other.

In the robot system 110 shown in FIG. 19, the light emitted from the light source 58 is supplied to the optical fiber sensors 118a, 118b from one of half-silvered mirrors 62a, 62b, 62c which is selected by the beam switcher 60 in a time-sharing fashion, and the reflected light beams from the optical fiber sensors 118a, 118b are detected by the reflected light detector 66. However, the X-direction shearing stress sensor section 132, the Y-direction shearing stress sensor section 134, and the Z-direction stress sensor section 136 of each of the optical fiber sensors 118a, 118b may be supplied with respective light beams from three independent light sources, and reflected light beams from the X-direction shearing stress sensor section 132, the Y-direction shearing stress sensor section 134, and the Z-direction stress sensor section 136 may be detected by three independent reflected light detectors. According to such a modification, it is possible to simultaneously detect shearing and perpendicular stresses applied from the object 12.

The optical fiber sensors 18a, 18b, 118a, 118b are not limited to detecting a gripped state of the object 12 gripped by the hands 16a, 16b, but are also applicable to the detection of a surface state of an object, for example.

What is claimed is:

1. An optical fiber sensor comprising:
a plurality of shearing stress sensor sections including respective optical fibers and a plurality of gratings for reflecting light beams having predetermined wavelengths, the gratings being disposed in the optical fibers and arrayed along a plane parallel to a direction in which a shearing stress is applied from an object to the shearing stress sensor sections; and
a perpendicular stress sensor section including an optical fiber and a plurality of gratings for reflecting light beams having predetermined wavelengths, the gratings being disposed in the optical fiber and arrayed along a plane parallel to a direction in which a perpendicular stress is applied from the object to the Perpendicular stress sensor section.

2. An optical fiber sensor according to claim 1, wherein each of the shearing stress sensor sections and the perpendicular stress sensor section comprises a flexible sheet body.

3. An optical fiber sensor according to claim 1, wherein the optical fibers of the shearing stress sensor sections extend respectively in two perpendicular directions in the plane parallel to the direction in which the shearing stress is applied from the object to the shearing stress sensor sections.

4. An optical fiber sensor according to claim 1, wherein the gratings of the shearing stress sensor sections are disposed in a plurality of different positions in the plane parallel to the direction in which the shearing stress is applied from the object to the shearing stress sensor sections, and the gratings reflect respective light beams having different wavelengths.

5. An optical fiber sensor according to claim 1, wherein each of the shearing stress sensor sections includes two adjacent gratings, and detects the direction and magnitude of the shearing stress based on shift directions in and shift amounts by which the wavelengths of light beams reflected respectively by the two adjacent gratings are shifted.

6. An optical fiber sensor according to claim 1, wherein the gratings of the perpendicular stress sensor section are disposed in a plurality of different positions in the plane perpendicular to the direction in which the perpendicular stress is applied from the object to the perpendicular stress sensor section, and the gratings reflect respective light beams having different wavelengths.

7. An optical fiber sensor comprising:
a stress sensor section including an optical fiber and a plurality of gratings for reflecting light beams having predetermined wavelengths, the gratings being disposed in the optical fiber; and
stress direction converting means for converting the direction of an applied stress which is different from the longitudinal axis of the optical fiber into a direction parallel to the longitudinal axis of the optical fiber, and transmitting the stress to the gratings in the converted direction.

8. An optical fiber sensor according to claim 7, wherein the stress direction converting means comprises a flat portion extending parallel to the longitudinal axis of the optical fiber and a stress transmitter extending from the flat portion to the optical fiber.

9. An optical fiber sensor according to claim 8, wherein the flat portion has a higher modulus of elasticity than the stress transmitter.

10. An optical fiber sensor according to claim 7, wherein the stress direction converting means is made of either one of rubber, resin, liquid crystal polymer, and carbon-fiber-reinforced plastic.
